(19) United States
(12) Patent Application Publication
(10) Pub. No.: US 2005/0019498 A1
(43) Pub. Date: Jan. 27, 2005

(54) Substrate treating method and apparatus

(75) Inventor: Atushi Osawa, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 10/890,595

(22) Filed: Jul. 13, 2004

(30) Foreign Application Priority Data
Jul. 15, 2003 (JP) JP2003-197243

(51) Int. Cl. B05D 3/00

(52) U.S. Cl. 427/331; 118/665

(57) ABSTRACT

A substrate treating method is disclosed, in which a treating solution containing phosphoric acid is heated for use in treating a substrate coated with a film including a material of high dielectric constant.

### BACKGROUND OF THE INVENTION

(1) Field of the Invention

This invention relates to a substrate treating method and apparatus for performing a predetermined treatment of semiconductor wafers and glass substrates for liquid crystal displays (hereinafter called simply substrates). More particularly, the invention relates to a technique for treating substrates coated with a film including a material of high dielectric constant.

(2) Description of the Related Art

Conventionally, oxide film or the like is used as gate insulating film of devices such as transistors in the semiconductor field. To form such oxide film or the like into a predetermined pattern, a mask pattern is formed on the oxide film, and then the substrate is immersed for a predetermined time in a treating tank storing a treating solution containing hydrofluoric acid.

In the semiconductor field of recent years, the increasingly refined structure of devices such as transistors has led to development of LSIs having multiple functions. While this trend has resulted in increases in the operating speed of circuits, the thin formation of gate insulating oxide film is reaching the limit. That is, an increase in leak current due to the thin film is posing a serious problem.

Then, as a means for solving this problem, materials of high dielectric constant are attracting attention as new materials capable of suppressing leak current; a possible replacement for the oxide film having been used as gate insulating film.

However, the above conventional technique has the following drawback.

The materials of high dielectric constant usable in the semiconductor field include metal oxides such as of aluminum and hafnium. However, these materials cannot be treated with solutions conventionally used in etching and cleaning. Although studies are being made on materials of high dielectric constant expected to replace the conventional materials, such new materials are not in wide use yet.

### SUMMARY OF THE INVENTION

This invention has been made having regard to the state of the art noted above, and its object is to provide a substrate treating method and apparatus for effectively treating substrates having a material of high dielectric constant.

To fulfill the above object, Inventor has attained the following findings. Inventor herein has conducted various experiments on conditions that a material of high dielectric constant may be treated selectively and that substrates are free from contamination by the material of high dielectric constant. It has been found as a result that the above conditions are satisfied by heating a treating solution containing phosphoric acid.

Based on the above findings, this invention provides a substrate treating method comprising a step of heating a treating solution containing phosphoric acid, and treating, with the treating solution, a substrate coated with a film including a material of high dielectric constant.

Inventor has conducted experiments in treating a material of high dielectric constant by using a heated treating solution containing phosphoric acid. It has been found as a result that the material of high dielectric constant may be treated at temperatures slightly above a certain temperature and higher. The experiments have confirmed that, by treating the material of high dielectric constant using the treating solution heated to such a temperature, the material of high dielectric constant may be treated selectively, and that substrates are free from contamination. Substrates coated with a material of high dielectric constant may be treated effectively by using a heated treating solution containing phosphoric acid.

It is preferable in this invention that the treating solution is heated to a temperature of at least 105° C. and below a boiling point of phosphoric acid.

It has been found that, when the treating solution containing phosphoric acid is heated to 105° C., the treating rate (e.g. etching rate) is higher for the material of high dielectric constant than for the oxide film excluding the material of high dielectric constant, thus selectively treating the material of high dielectric constant. The upper limit of heating temperature is the boiling point of phosphoric acid (213° C.).

Preferably, the treating solution contains phosphoric acid in a concentration of 65 to 100% by weight.

An experiment conducted by varying the concentration of phosphoric acid in the treating solution has shown that substrates are treated effectively when the concentration is in the range of 65 to 100% by weight. The phosphoric acid concentration below 65% will result in an inappropriate treatment, with a diminished difference in treating rate between the material of high dielectric constant and the oxide film excluding this material.

In this invention, the material of high dielectric constant, preferably, is an oxide including at least one of aluminum Al, hafnium Hf and zirconium Zr, silicate, or aluminate.

Specific examples of the material of high dielectric constant include Al₂O₃, HfSiₓO_{y}, HfO₂, HfSiₓO_{y}, ZrAlₓO_{y} and ZrO₂.

In another aspect of the invention, a substrate treating apparatus is provided for treating a substrate coated with a film including a material of high dielectric constant, the apparatus comprising:

a treating tank for receiving the substrate for treatment;

a treating solution supply pipe for supplying a treating solution containing phosphoric acid into the treating tank; and

a heating device for heating the treating solution.

The treating solution containing phosphoric acid is supplied into the treating tank through the treating solution supply pipe. By heating the treating solution with the heating device, the substrate coated with a material of high dielectric constant may be treated effectively.

In a further aspect of the invention, a substrate treating method comprises a step of treating a substrate coated with a film including a material of high dielectric constant, with a treating solution containing phosphoric acid and sulfuric acid.

Inventor has found that, with a treating solution prepared by mixing sulfuric acid into phosphoric acid, and with an increase in sulfuric acid concentration, the treating rate for the material of high dielectric constant improves over the case of containing only phosphoric acid. With a further increase in sulfuric acid concentration, the treating rate will fall, but the fall is greater for the oxide film excluding the material of high dielectric constant (although the treating rate increases once). Thus, the material of high dielectric constant may be treated selectively and effectively by using the treating solution containing phosphoric acid and sulfuric acid in treating substrates coated with the material of high dielectric constant.

Preferably, the treating solution contains sulfuric acid in a concentration of at most 65% by weight.

In an experiment conducted by varying the mixing ratio of sulfuric acid, the above tendency of treating rate has been found to hold when the sulfuric acid concentration is above 0% by weight and does not exceed 65% by weight, thereby enabling an effective treatment.

In a still further aspect of the invention, a substrate treating apparatus is provided for treating a substrate coated with a film including a material of high dielectric constant, the apparatus comprising:

a treating tank for receiving the substrate for treatment;

a treating solution supply pipe for supplying a treating solution containing phosphoric acid and sulfuric acid into the treating tank; and

an adjusting device for adjusting a sulfuric acid concentration in the treating solution.

The treating solution containing phosphoric acid and sulfuric acid is supplied into the treating tank through the treating solution supply pipe. By adjusting the sulfuric acid concentration in the treating solution, the substrate coated with a material of high dielectric constant may be treated effectively.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a graph showing results of an experiment conducted with a method in a first embodiment of this invention, which shows a temperature dependence of etching rate;

FIG. 2 is a graph showing results of an experiment conducted with the method in the first embodiment, which shows a concentration dependence of etching rate;

FIGS. 3A through 3C are explanatory views showing a specific treatment by the method according to this invention, in which FIG. 3A shows a state before etching, FIG. 3B shows a state after dry etching, and FIG. 3C shows a state after etching with a treating solution;

FIG. 4 is a view showing an outline of a substrate treating apparatus in the first embodiment;

FIG. 5 is a graph showing results of an experiment conducted with a method in a second embodiment of this invention, which shows a sulfuric acid concentration dependence of etching rate; and

FIG. 6 is a view showing an outline of a substrate treating apparatus in the second embodiment.

### DESCRIPTION OF THE PREFERRED EMBODIMENTS

Preferred embodiments of this invention will be described hereinafter with reference to the drawings.

### First Embodiment

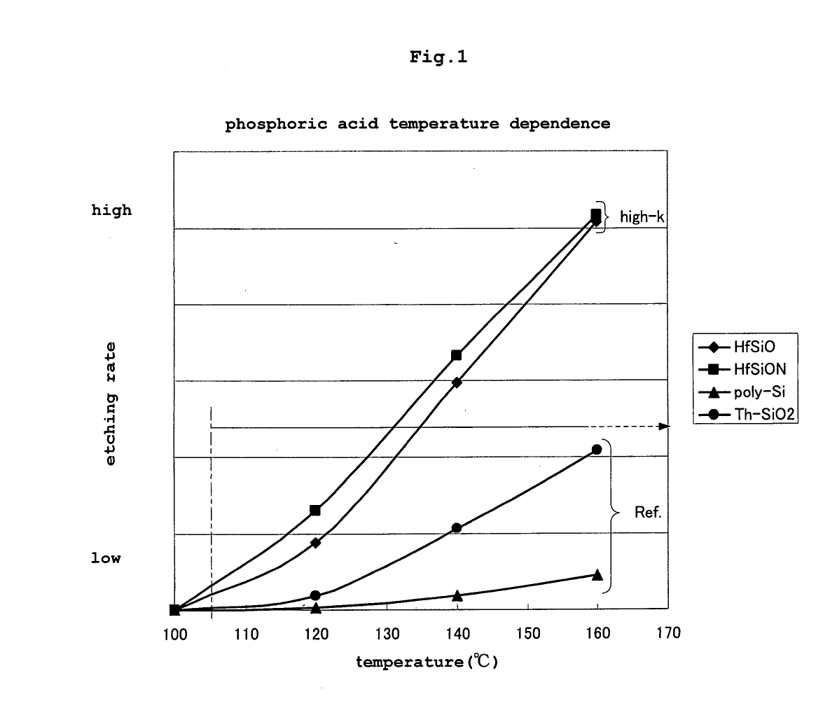

FIG. 1 is a graph showing results of an experiment conducted with a method in a first embodiment of this invention, which shows a temperature dependence of etching rate.

This graph is a graphic representation of etching rates which are results of an experiment conducted in etching substrates coated with a film including a material of high dielectric constant. The etching process was carried out by using, as an etching solution, a treating solution containing phosphoric acid. The solution was heated to varied temperatures, and the etching rate was measured at the varied temperatures. Specifically, the treating solution was heated to 100° C., 120° C., 140° C. and 160° C. The concentration of phosphoric acid in the treating solution was about 90% by weight.

Substrates coated with a film including hafnium Hf which is a material of high dielectric constant were used as samples in the experiment. And polysilicon and thermal oxidation film as used in the prior art were used for comparison with the above material of high dielectric constant.

As seen from the graph in FIG. 1, as the temperature of the heated treating solution containing phosphoric acid exceeds 100° C., the etching rate begins to show a large difference between the materials of high dielectric constant (group labeled high-k in the drawing) and the conventional materials (group labeled Ref. in the drawing). At temperatures slightly above 120° C. and higher, the etching rate for the materials of high dielectric constant becomes notably higher than for the conventional materials.

Thus, where a material of high dielectric constant is used as gate insulating oxide film, the treating solution exerts very little action on the conventional materials used for substrates. The experiment demonstrates that the materials of high dielectric constant may be selectively treated by the above treating solution. Since the treating solution contains phosphoric acid, organic substances may be removed, and the substrates are free from contamination by the material of high dielectric constant dissolving from the film.

The above experimental results show that proper etching rates are provided by the treating solution heated to a temperature range exceeding about 105° C., which therefore is a practical range. The upper limit of temperature is the boiling point of phosphoric acid which is 213° C. Consequently, substrates coated with a film including a material of high dielectric constant may be treated effectively by heating the treating solution containing phosphoric acid to 105 to 213° C., preferably 120 to 160° C. At temperatures below 120° C. the treatment would take a long time, and temperatures above 160° C. would require additional cost in taking measures to cope with heating of the apparatus.

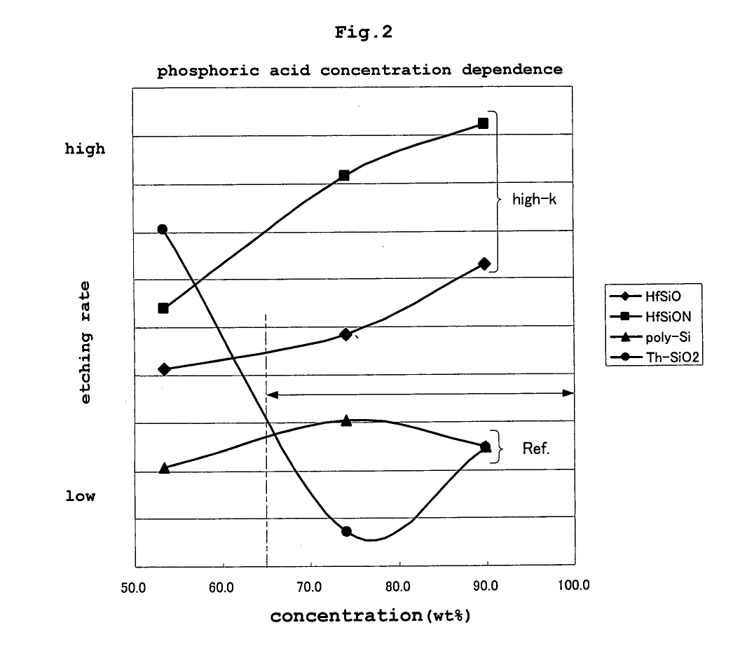

FIG. 2 refers next. FIG. 2 is a graph showing results of an experiment conducted with the method in the first embodiment, which shows a concentration dependence of etching rate

This graph is a graphic representation of etching rates which are results of an experiment conducted by using the same samples used in the temperature dependence experiment described above. The etching process was carried out by using a treating solution containing phosphoric acid, and the etching rate was measured while varying phosphoric acid concentration. Specific concentrations were 53.4% by weight, 74.0% by weight and 89.9% by weight. The temperature of the treating solution was about 115° C.

As seen from the graph in FIG. 2, as the phosphoric acid concentration of the treating solution exceeds 60% by weight, the etching rate begins to show a difference between the materials of high dielectric constant (group labeled high-k in the drawing) and the conventional materials (group labeled Ref. in the drawing). At concentrations slightly above 65% by weight and higher, the etching rate for the materials of high dielectric constant becomes higher than for the conventional materials.

These experimental results show that proper etching rates are provided by the treating solution with a phosphoric acid concentration in a range exceeding about 65% by weight, which therefore is a practical range. The upper limit of concentration inevitably is 100% by weight. Consequently, substrates coated with a film including a material of high dielectric constant may be treated effectively by a treating solution with the phosphoric acid concentration adjusted to 65 to 100% by weight.

The material of high dielectric constant contemplated by this invention is an oxide including at least one of aluminum Al, hafnium Hf and zirconium Zr, silicate, or aluminate. Specific examples include Al₂O₃, HfSiₓO_{y}, HfO₂, HfSiₓO_{y}, ZrAlₓO_{y} and ZrO₂.

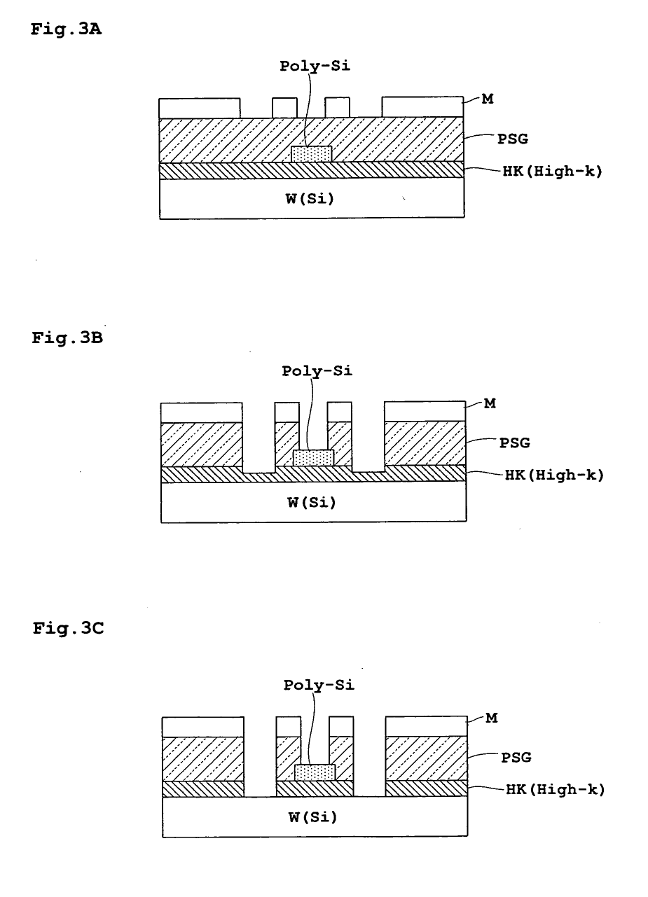

Next, a specific example of treatment by the above substrate treating method will be described briefly with reference to FIGS. 3A-3C. FIGS. 3A through 3C are explanatory views showing a specific treatment by the method according to this invention, in which FIG. 3A shows a state before etching, FIG. 3B shows a state after dry etching, and FIG. 3C shows a state after etching with the treating solution.

A wafer W has a material of high dielectric constant (High-k) HK, Poly-Si acting as gate electrodes, and PSG already formed on Si. Further a mask (resist) M is selectively formed thereon. Since the treating solution contains phosphoric acid, the mask M preferably is a material including Poly-Si, SiO₂ or SiN resistant to acid.

As shown in FIG. 3A, the wafer W with the mask M formed thereon is dry-etched. As a result, as shown in FIG. 3B, portions of the PSG not covered by the mask M are etched, and the material of high dielectric constant (High-k) HK is dry-etched halfway in the direction of thickness.

Finally, the dry-etched wafer W is immersed in a treating solution heated to the above-noted range. As a result, as shown in FIG. 3C, the remaining parts of the material of high dielectric constant (High-k) HK are etched and removed by the treating solution.

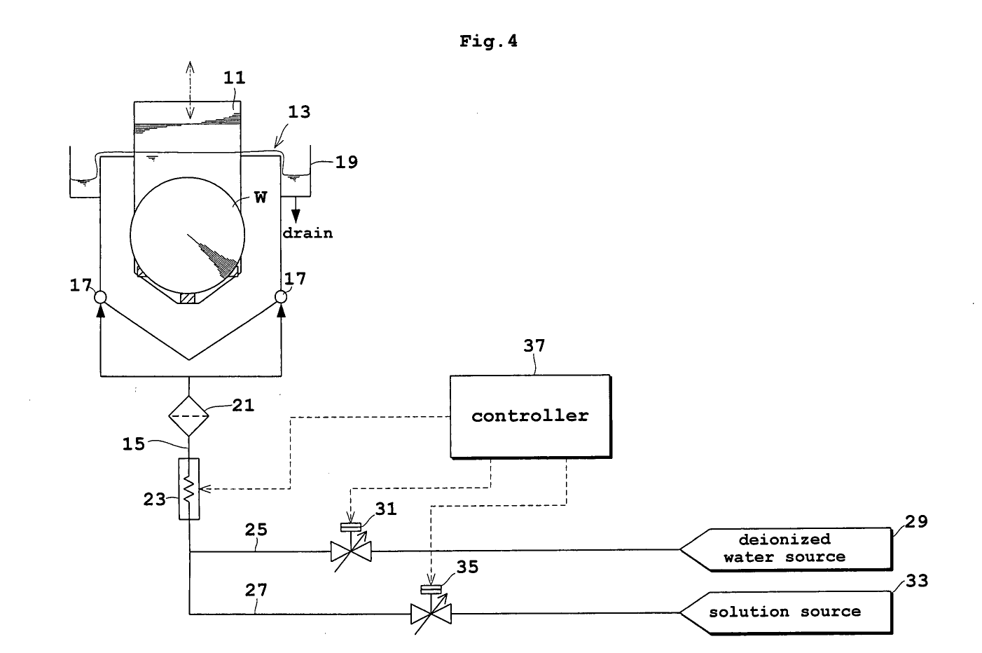

Next, a substrate treating apparatus suitable for carrying out the above substrate treating method will be described with reference to FIG. 4. FIG. 4 is a view showing an outline of a substrate treating apparatus in the first embodiment.

This substrate treating apparatus includes a holding arm 11, a treating tank 13 and treating solution piping 15. The holding arm 11 holds a plurality of wafers W under treatment, and is vertically movable between a position above the treating tank 13 and an immersed position (treating position) shown in FIG. 4. The treating tank 13 has injection pipes 17 arranged in bottom positions thereof for introducing the above-noted treating solution containing phosphoric acid. A collecting tank 19 is formed around an upper portion of the treating tank 13 for collecting and discharging overflows of the treating solution. The treating solution piping 15 is connected to the injection pipes 17.

The treating solution piping 15 has a filter 21, a heater 23 which corresponds to the heating device in this invention, a first supply line 25 and a second supply line 27. The filter 21 serves to remove particles and the like from the treating solution. The heater 23 heats and adjusts the treating solution to a predetermined temperature. The first supply line 25 has a deionized water source 29 connected thereto, and a control valve 31 for opening and closing the supply line 25 and controlling the flow rate therethrough. The second supply line 27 has a treating solution source 33 connected thereto and a control valve 35 for opening and closing the supply line 27 and controlling the flow rate therethrough. The treating solution stored in the treating solution source 33 is adjusted to the above-noted phosphoric acid concentration in advance.

A controller 37 controls opening and closing of the control valves 31 and 35 and the flow rates therethrough. The controller 37 controls also the heater 23 to heat the treating solution flowing through the treating solution piping 15 to a temperature in the above-noted temperature range. Further, the controller 37 controls the control valves 31 and 35 as necessary to fine-adjust the phosphoric acid concentration in the treating solution to a concentration in the above-noted concentration range by adding deionized water.

In the substrate treating apparatus having the above construction, the controller 37 opens the control valve 35 to supply the treating solution of predetermined concentration to the treating solution piping 15 The treating solution supplied to the treating solution piping 15 is heated to the predetermined temperature by the heater 23, and then supplied to the treating tank 13. The treating solution fills the treating tank 13 and overflows it into the collecting tank 19. Then, the holding arm 11 on standby above the treating tank 13, while holding the wafers W, descends to the immersed position shown in FIG. 4. After elapse of a predetermined time, the controller 37 closes the control valve 35, and opens the control valve 31 to supply deionized water into the treating tank 13. As a result, the etching treatment of the wafers W is stopped to give way to deionized water cleaning treatment.

The substrate treating apparatus having the above construction can carry out the foregoing substrate treating method to treat effectively the wafers W coated with a film having a material of high dielectric constant.

### Second Embodiment

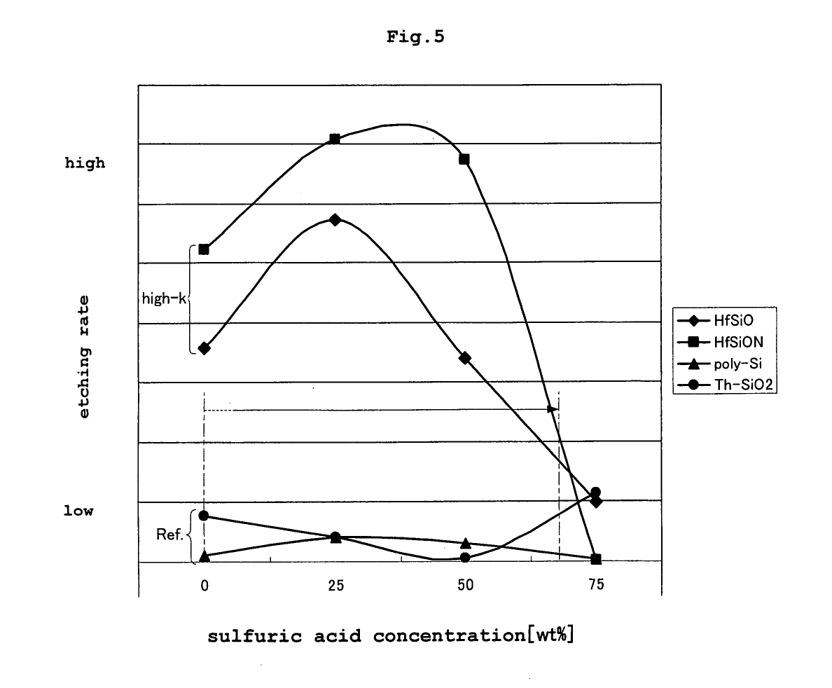

FIG. 5 is a graph showing results of an experiment conducted with a method in a second embodiment of this invention, which shows a sulfuric acid concentration dependence of etching rate.

This graph is a graphic representation of etching rates which are results of an experiment conducted in etching substrates coated with a film including a material of high dielectric constant. The etching process was carried out by using a treating solution containing phosphoric acid and sulfuric acid, and the etching rate was measured while varying sulfuric acid concentration. Specifically, a mixing ratio between phosphoric acid and sulfuric acid (a weight ratio of sulfuric acid to phosphoric acid) was varied to 0% by weight, 25% by weight, 50% by weight and 75% by weight. The temperature of the treating solution was 120° C. which was in the temperature range noted in the first embodiment. The samples used in this experiment are the same as those in the first embodiment.

As seen from the graph in FIG. 5, with an increase in the sulfuric acid concentration of the treating solution containing phosphoric acid and sulfuric acid, the etching rate temporarily increases for etching the materials of high dielectric constant (labeled high-k in the drawing), reaching a peak at adjacent 25 to 30% by weight, but thereafter decreases. On the other hand, the etching rate for the conventional materials (labeled Ref in the drawing) temporarily improves, but tends to be lower than for the materials of high dielectric constant, high-k, until the concentration exceeds the neighborhood of 65% by weight. Thus, the etching rate is lower for the conventional materials, Ref., than for the materials of high dielectric constant, high-k, until the sulfuric concentration reaches 65% by weight or thereabouts.

These experimental results show that proper etching rates are provided by the treating solution with a sulfuric acid concentration up to about 65% by weight, allowing a selective use of the materials of high dielectric constant and conventional materials. The lower limit of concentration is a value corresponding to sulfuric acid contained even in a slight quantity (practically about 5% by weight). Consequently, substrates coated with a film including a material of high dielectric constant may be treated effectively by a treating solution containing phosphoric acid and sulfuric acid, with the phosphoric acid concentration adjusted to the above range.

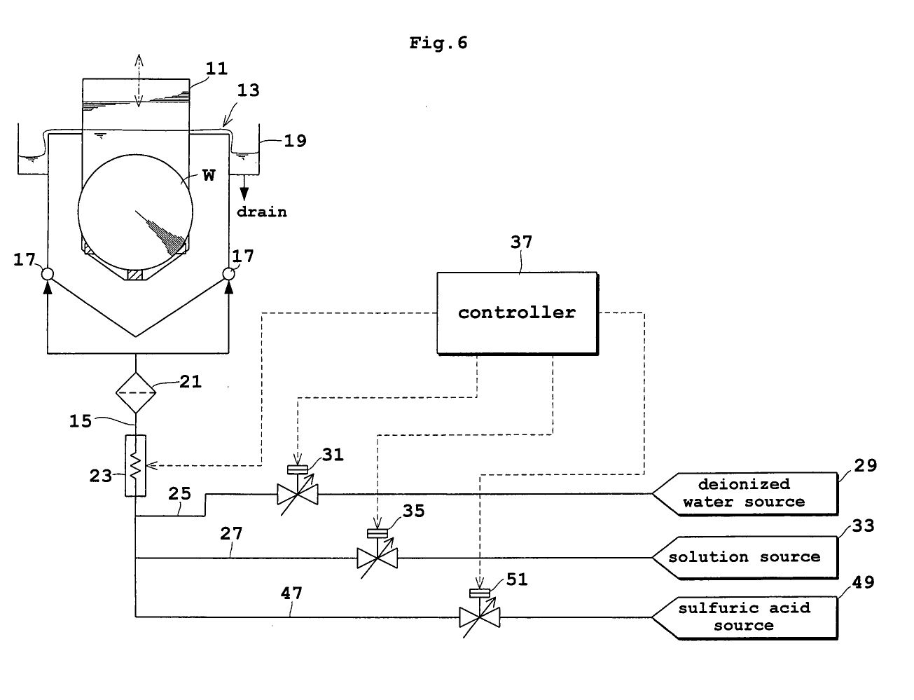

Next, a substrate treating apparatus suitable for carrying out the above substrate treating method will be described with reference to FIG. 6. FIG. 6 is a view showing an outline of a substrate treating apparatus in the second embodiment. Like reference numerals are used to identify like parts which are the same as in the first embodiment and will not be described again.

This substrate treating apparatus includes, besides the construction in the first embodiment described above, a third supply line 47 communicating with the treating solution piping 15, a sulfuric acid source 49 that supplies sulfuric acid to the third supply line 47, and a control valve 51 for adjusting the flow rate of sulfuric acid through the third supply line 47. The control valve 51 corresponds to the adjusting device in this invention.

The apparatus having the above construction successively performs treating processes as does the apparatus in the first embodiment described hereinbefore. The treating solution supplied to the treating tank 13 now contains sulfuric acid in a predetermined concentration. That is, the treating solution comprises a mixture of phosphoric acid and sulfuric acid. The control valve 51 is controlled by the controller 37 to adjust the sulfuric acid concentration to be 65% or less by weight as described above.

The substrate treating apparatus having the above construction can carry out the foregoing substrate treating method to treat effectively the wafers W coated with a film having a material of high dielectric constant.

In the foregoing embodiments, etching has been described as an example of substrate treatment. The invention provides the same functions and effects where substrate treatment is cleaning instead of etching.

The foregoing apparatus have been described as treating a plurality of wafers W en bloc in a batch process. This invention is applicable also to the single-wafer processing type that treats one wafer W after another.

The apparatus described above discharges the treating solution supplied to the treating tank 13. The methods according to this invention are applicable also to the type of apparatus that circulates the treating solution for repeated use instead of discharging the treating solution.

This invention may be embodied in other specific forms without departing from the spirit or essential attributes thereof and, accordingly, reference should be made to the appended claims, rather than to the foregoing specification, as indicating the scope of the invention.

1. A substrate treating method comprising a step of heating a treating solution containing phosphoric acid, and treating, with said treating solution, a substrate coated with a film including a material of high dielectric constant.

2. A substrate treating method as defined in claim 1, wherein said treating solution is heated to a temperature of at least 105° C. and below a boiling point of phosphoric acid.

3. A substrate treating method as defined in claim 1, wherein said treating solution contains phosphoric acid in a concentration of 65 to 100% by weight.

4. A substrate treating method as defined in claim 2, wherein said treating solution contains phosphoric acid in a concentration of 65 to 100% by weight.

5. A substrate treating method as defined in claim 1, wherein said material of high dielectric constant is an oxide including at least one of aluminum Al, hafnium Hf and zirconium Zr, silicate, or aluminate.

6. A substrate treating method as defined in claim 2, wherein said material of high dielectric constant is an oxide including at least one of aluminum Al, hafnium Hf and zirconium Zr, silicate, or aluminate.

7. A substrate treating method as defined in claim 3, wherein said material of high dielectric constant is an oxide including at least one of aluminum Al, hafnium Hf and zirconium Zr, silicate, or aluminate.

8. A substrate treating method as defined in claim 4, wherein said material of high dielectric constant is an oxide including at least one of aluminum Al, hafnium Hf and zirconium Zr, silicate, or aluminate.

9. A substrate treating apparatus for treating a substrate coated with a film including a material of high dielectric constant, said apparatus comprising:
a treating tank for receiving said substrate for treatment;
a treating solution supply pipe for supplying a treating solution containing phosphoric acid into said treating tank; and
heating device for heating said treating solution.

10. A substrate treating apparatus as defined in claim 9, wherein said heating device is arranged to heat said treating solution to a temperature of at least 105° C. and below a boiling point of phosphoric acid.

11. A substrate treating apparatus as defined in claim 9, wherein said treating solution supply pipe is arranged to supply said treating solution containing phosphoric acid in a concentration of 65 to 100% by weight.

12. A substrate treating apparatus as defined in claim 10, wherein said treating solution supply pipe is arranged to supply said treating solution containing phosphoric acid in a concentration of 65 to 100% by weight.

13. A substrate treating apparatus as defined in claim 9, wherein said material of high dielectric constant is an oxide including at least one of aluminum Al, hafnium Hf and zirconium Zr, silicate, or aluminate.

14. A substrate treating apparatus as defined in claim 10, wherein said material of high dielectric constant is an oxide including at least one of aluminum Al, hafnium Hf and zirconium Zr, silicate, or aluminate.

15. A substrate treating method comprising a step of treating a substrate coated with a film including a material of high dielectric constant, with a treating solution containing phosphoric acid and sulfuric acid.

16. A substrate treating method as defined in claim 15, wherein said treating solution contains sulfuric acid in a concentration of at most 65% by weight.

17. A substrate treating method as defined in claim 15, wherein said treating solution contains sulfuric acid in a concentration of at least 5% by weight.

18. A substrate treating method as defined in claim 16, wherein said treating solution contains sulfuric acid in a concentration of at least 5% by weight.

19. A substrate treating apparatus for treating a substrate coated with a film including a material of high dielectric constant, said apparatus comprising:
a treating tank for receiving said substrate for treatment;
a treating solution supply pipe for supplying a treating solution containing phosphoric acid and sulfuric acid into said treating tank; and
adjusting device for adjusting a sulfuric acid concentration in said treating solution.

20. A substrate treating apparatus as defined in claim 19, wherein said adjusting device is arranged to adjust the sulfuric acid concentration in said treating solution to at most 65% by weight.
